(19) United States
(12) Patent Application Publication
(10) Pub. No.: US 2004/0035879 A1
(43) Pub. Date: Feb. 26, 2004

(54) Method and apparatus for bird dispersion

(76) Inventor: Bruce Vergote, Reed City, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/641,857

(22) Filed: Aug. 15, 2003

Related U.S. Application Data
(60) Provisional application No. 60/405,633, filed on Aug. 23, 2002.

(51) Int. Cl. B67D 5/00

(52) U.S. Cl. 222/3

(57) ABSTRACT

A method for dispersing a bird repellant includes providing a tank defining an interior space, and placing a quantity of bird repellant in liquid form within the interior space of the tank. The method also includes providing a nozzle assembly including at least one nozzle in fluid communication with the interior space of the tank, wherein the at least one nozzle includes a discharge aperture. The method further includes providing an air pressurizing source, and atomizing a portion of the bird repellant by moving air over the discharge aperture of the at least one nozzle via the air pressuring source, thereby providing an atomized bird repellant.

### CROSS REFERENCE TO RELATED APPLICATION

The present application claims priority from previously-filed U.S. Provisional Patent Application No. 60/405,633, filed Aug. 23, 2002, and to which priority is claimed.

### BACKGROUND OF THE INVENTION

The present invention relates to a method for dispersing a bird repellant, and in particular to a method and related apparatus for atomizing a bird repellant in liquid form.

Bird repellants are utilized in a wide variety of environments, including fruit orchards, crop fields, barns for livestock, airports, and the like. The bird repellants are typically distributed via large fogging machines that include heating elements, such as heating coils that were heated by an associated spark plug. The heat from the coils vaporize a liquid bird repellant containing the active ingredient of methyl anthranilate, thereby creating a thick “smoke” that hangs in the surrounding air. The methyl anthranilate containing smoke is then inhaled by birds passing therethrough, causing a discomfort to the birds and repelling them from the smoke ladened area.

Heretofore, the fogging machines as used are not exceedingly effective as the particle size of the vaporized bird repellant is too large to remain airborne for all but a short time period. Further, the heating process associated with the fogging machines results in the created smoke being readily visible to both humans and birds. The visibility to the birds results in the birds simply avoiding the smoke and/or the birds initiating a “self-defense mechanism” in which the birds close a mucous membrane to cover their eyes, and further closing their throats to avoid inhaling the smoke. The visibility to humans creates visual problems within enclosed areas such as aircraft hangars, dairy barns, and the like, and safety problems around airports and highways. Other disadvantages include the significant noise associated with the operation of known fogging devices, the significant cost for bird repellant due to the relative ineffectiveness of the process, and reduced effectiveness of the bird repellant due to the heating process.

Another known application process includes spraying orchards and fields with bird repellant in liquid form. This is typically accomplished via a commercial spraying operation as is well known. Heretofore, these spraying processes have resulted in a heavy coating of the repellant being placed on the fruits and/or crops, as is required to adequately repel the birds. The heavy coating can cause a distaste to the covered fruit. Another disadvantage of the spraying process is that the chemical methyl anthranilate breaks down into an anthranilic acid that is phototoxic to the leaves of many plants, thereby damaging the associated fruit trees. Other disadvantages include the short active life of the bird repellant once applied, thereby requiring repeated heavy coatings, and the relative ineffectiveness of the repellant when ingested by the birds, thereby again requiring repeatedly heavy applications of the product.

An effective method for dispersing a liquid bird repellant is desired that is highly effective at repelling birds, is cost effective, reduces the amount of bird repellant required to effectively repel the birds, is safe to use around consumable products, is safe to use around areas such as airports, and may be applied with minimal intrusions.

### SUMMARY OF THE INVENTION

One aspect of the present invention is to provide a method for dispersing a bird repellant that includes providing a tank defining an interior space, placing a quantity of bird repellant in liquid form within the interior space of the tank, and providing a nozzle assembly including at least one nozzle in fluid communication with the interior space of the housing, wherein the at least one nozzle includes a discharge aperture. The method further includes providing an air pressurizing source, and atomizing a portion of the bird repellant by moving air over the discharge aperture of the at least one nozzle via the air pressurizing source, thereby providing an atomized bird repellant.

Another aspect of the present invention is to provide a method for dispersing a bird repellant utilizing a hazing apparatus that includes a tank having an interior space adapted to receive a liquid within at least a portion thereof, and a nozzle assembly located within the interior space of the tank and having a nozzle housing and at least one nozzle located within the nozzle housing, wherein each nozzle includes a discharge aperture. The apparatus also includes a supply line providing fluid communication between the portion of the interior space of the tank containing the liquid and the at least one nozzle, and a first filter member located so as to filter the fluid prior to the fluid entering the nozzle. The hazing apparatus further includes a compressor in fluid communication with the nozzle housing and adapted to provide an air flow through the nozzle housing, and a controller in operable communication with the compressor. The hazing apparatus still further includes a second filter member located so as to filter an atomized fluid exiting the nozzle assembly. The method includes placing a quantity of bird repellant in liquid form within the interior space of the housing and atomizing a portion of the liquid bird repellant by forcing air over the discharge aperture of the at least one nozzle via the compressor, thereby providing an atomized bird repellant.

Yet another aspect of the present invention is to provide an apparatus for dispersing a bird repellant that includes a tank having an interior space adapted to receive a liquid bird repellant within at least a portion thereof, and a nozzle assembly located within the interior space of the tank and having a nozzle housing and at least one nozzle located within the nozzle housing. The nozzle housing includes a first portion, a second portion and an O-ring providing a fluid-tight seal between the first portion and the second portion, wherein the O-ring is constructed of a material substantially non reactive with the bird repellant. The at least one nozzle is in fluid communication with the portion of the interior space of the tank and is adapted to receive the liquid bird repellant. Each nozzle includes a discharge aperture. The apparatus further includes a compressor in fluid communication with the nozzle housing and adapted to provide an air flow through the nozzle housing and over the discharge aperture of the at least one nozzle, which draws the fluid bird repellant from the at least one nozzle and atomizes the fluid bird repellant to provide an atomized bird repellant.

The present inventive method and related apparatus provide a low cost and economical solution to dispersing birds from both interior spaces and exterior areas. The methods and related apparatus also provides a low-noise, less obstructive, and less intrusive solution to bird dispersion. Specifically, the methods and apparatus are highly effective at dispersing birds, while reducing the amount of bird repellant required to be effective and simultaneously increasing the relative effectiveness of the repellant, safe to use around consumable products, and safe to use around safety-critical areas such as airports.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a bird dispersion apparatus embodying the present invention, wherein a portion of a housing and tank of an atomizing unit is cutaway to show components contained therein, and wherein a portion of an outer housing of an air flow delivery unit is cutaway to show components contained therein;

FIG. 2 is an exploded perspective view of a nozzle assembly and a plurality of fluid communication lines;

FIG. 3 is a cross-sectional side view of a portion of the nozzle assembly taken along the line III-III, FIG. 2;

FIG. 4 is an enlarged perspective view of a nozzle;

FIG. 5 is a segmented, exploded perspective view of the tank, a filter assembly, and a gauge member; and

FIG. 6 is a cross-sectional side elevational view of the atomizing unit.

### DETAILED DESCRIPTION OF THE PREFERRED EMBODIMENTS

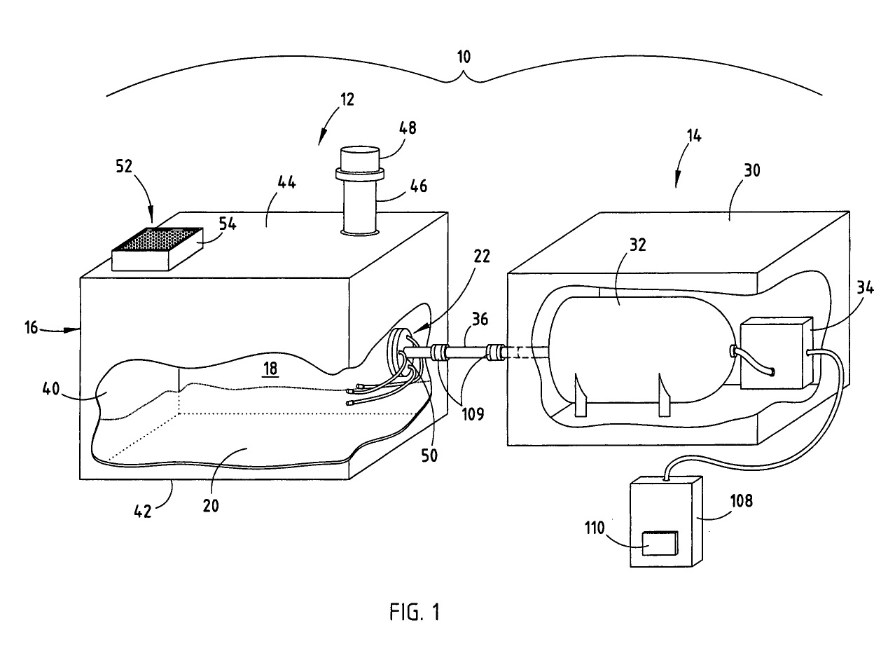

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

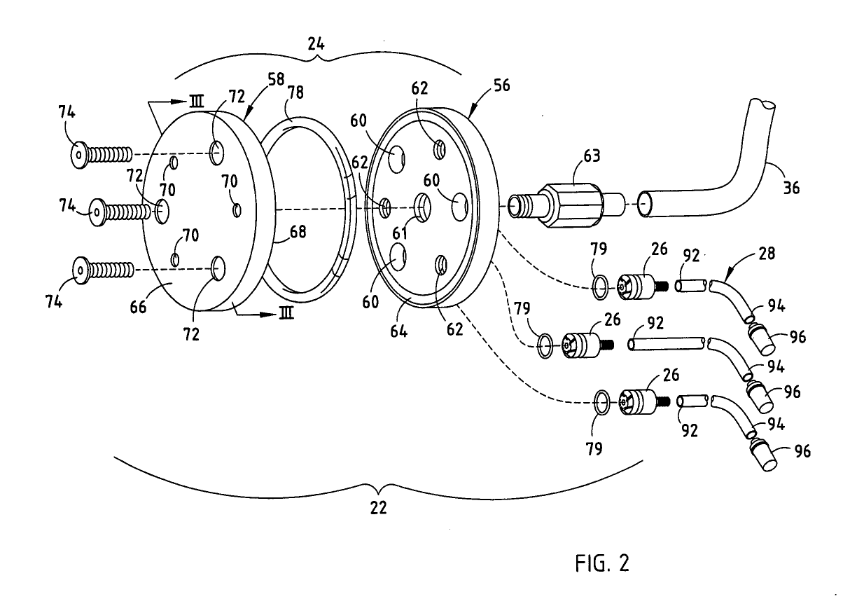

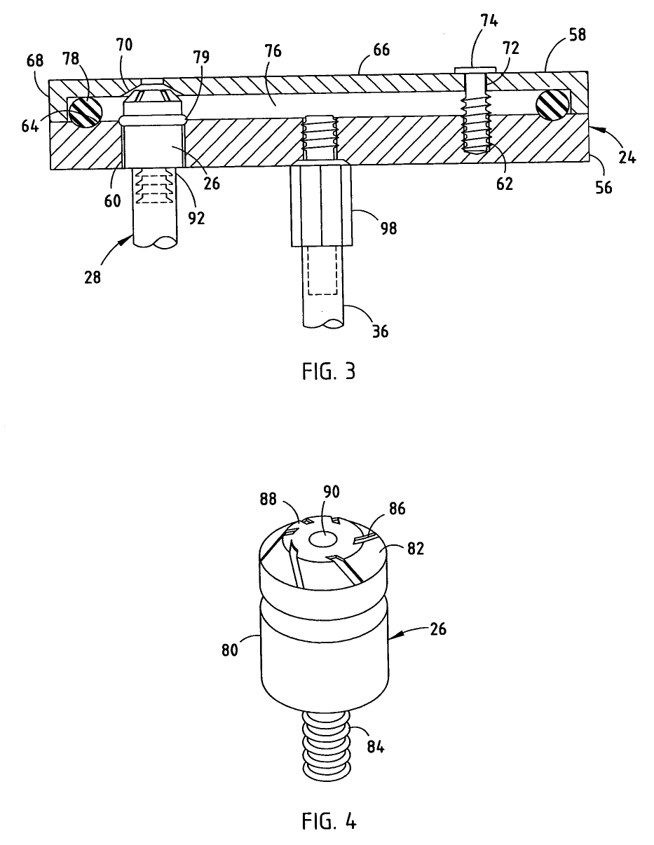

The reference numeral 10 (FIG. 1) generally designates a bird dispersion apparatus embodying the present invention. In the illustrated example, the dispersion apparatus 10 includes an atomizing unit 12 and an air flow delivery unit 14. The atomizing unit 12 includes a tank 16 having an interior space 18 adapted to receive a bird repellant 20 in liquid form within at least a portion thereof, and a nozzle assembly 22 (FIG. 2) located within the interior space 18 of the tank 16. The nozzle assembly 22 includes a nozzle housing 24 and a plurality of circumferentially-spaced nozzles 26 contained within the nozzle housing 24. A plurality of fluid supply lines 28 provide fluid communication between the portion of the interior space 18 of the tank 16 containing the liquid bird repellant 20 and each nozzle 26.

The delivery unit 14 includes an outer housing 30 that houses an air compressor 32 and a controller 34 in operable communication with the air compressor 32. An air supply line 36 provides fluid communication between the air compressor 32 and the nozzle assembly 22. The air compressor 32 provides an air flow through the supply line 36 to the nozzle housing 24 and over an area surrounding each nozzle 26, thereby creating a low pressure area surrounding the nozzle 26 via a venturi-type effect and drawing the liquid bird repellant 20 from the nozzles 26 and atomizing the liquid bird repellant 20 to provide an atomized bird repellant 38.

The tank 16 of the atomizing unit 12 includes a plurality of sidewalls 40, a bottom wall 42 and a top wall 44 that cooperate to define the interior space 18. The tank 16 also includes a refill tube 46 extending upwardly from the top wall 44 and in fluid communication with the interior space 18, thereby allowing replenishment of the liquid bird repellant 20 into the tank 16, and a cap member 48 threadably received on the refill tube 46. The tank 16 further includes an inlet aperture 50 extending through a sidewall 40, and an exhaust port 52 extending through the top wall 44. A plurality of walls 54 extend upwardly from the top wall 44 of the tank 16 and are configured to surround the exhaust port 52. The tank 16 is preferably constructed of a material that is substantially non-reactive with a bird repellant which contains the active ingredient of methyl anthranilate, such as Fog Force as available from Becker Underwood of Ames, Iowa, and Soygold, as available from AG Environmental Products, L.L.C. of Lenexa, Kans., and is more preferably constructed of stainless steel.

The nozzle housing 24 of the nozzle assembly 22 includes a body member 56 and a cover member 58. The body member 56 includes a plurality of circumferentially spaced apertures 60 that receive the nozzles 26 therein, and a plurality of hardware receiving apertures 62, interspaced with the apertures 60. A centrally-located aperture 61 extends through the body member 56 and threadably receives a fitting 63 providing connection of the nozzle housing 24 to the air supply line 36. The bottom member 56 further includes a circumferentially extending channel 64. The cover member 58 includes an outer face 66 and lip portion 68 extending circumferentially about and outwardly from the face 66. The cover member 58 further includes a plurality of circumferentially-spaced frusto conical apertures 70 that receive a portion of the nozzles 26 therein, and a plurality of fastener receiving apertures 72 interspaced with apertures 70. In assembly, a plurality of mechanical fasteners such as bolts 74 extend through the apertures 72 and are threadably received within the apertures 62, thereby connecting the cover member 58 with the body member 56 and defining an open space 76 therebetween. An O-ring 78 is located within the channel 64 of the body member 56 and is trapped between the cover member 58 and the body member 56, thereby creating a fluid-tight seal therebetween. A plurality of O-rings 79 are located about each nozzle 26, thereby providing a fluid-tight seal between each nozzle 26 and the nozzle housing 24. The O-rings 78, 79 are preferably constructed of a material that is substantially non-reactive with a bird repellant 20 that contains the active ingredient methyl anthranilate, such Fog Force as available from Becker Underwood of Ames, Iowa, and Soygold, as available from AG Environmental Products, L.L.C. of Lenexa, Kans., and is more preferably constructed of VITON® as available from E. I. Du Pont De Nemours and Company of Delaware.

Each nozzle 26 (FIG. 4) is a venturi effect-type nozzle that includes a body portion 80, a head portion 82, an O-ring receiving channel located between the body portion 80 and the head portion 82, and male adapted 84. The head portion includes a plurality of angled slots 86 radiating outwardly towards an outer edge 88 of the head portion 82. The angled slots 86 operate to more effectively atomize the liquid bird repellant 20 by creating a “tornado-type” effect. Each nozzle 26 further includes a centrally-located discharge aperture 90.

The supply lines 28 providing fluid communication between the portion of the tank 16 containing the liquid bird repellant 20 and the nozzles 26 are constructed of a flexible poly-piping and include a proximate end 92 and a distal end 94. The proximate end 92 of each supply line 28 is coupled with the male adapter 84 of each nozzle 26. Although illustrated as a press-type fit other methods of connection can be utilized. The distal end 94 of each supply line 28 has a brass filter member 96 connected thereto, and that operates to filter the liquid bird repellant 20 prior to delivery to the associated nozzle 26.

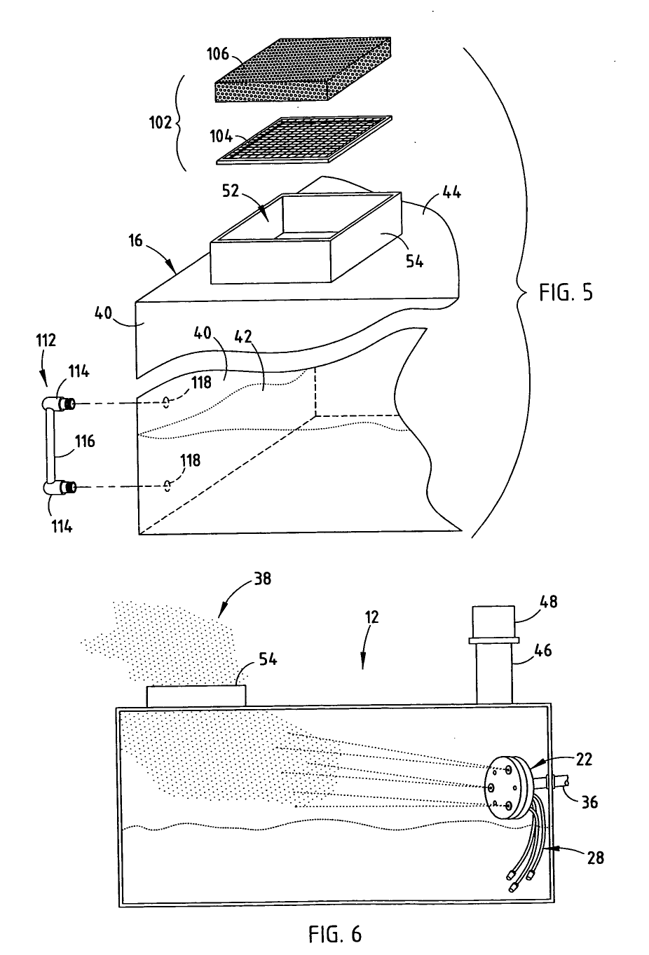

The atomizing unit 12 further includes a filter assembly 102 (FIG. 5) that includes a screen member 104 and a filter member 106. The filter member 106 is constructed of a foam such as Unifoam Polyurethane Foam as available from Adams Foam Rubber of Chicago, Ill. In assembly, the screen member 104 is placed between the walls 54 of the tank 16 and is attached to the tank 16 above the exhaust port 52.

The air compressor 32 of the delivery unit 14 is a low-pressure air compressor providing approximately 40 psi at 1.5 cfm. The air supply line 36 provides fluid communication between the air compressor 32 and the nozzle assembly 22 and includes a pair of quick-release adapters 109, thereby allowing any length of line 36 to be used and allowing the delivery unit 14 to be placed at any distance from the atomizing unit 12. In the illustrated example, the compressor 32 is in electrical communication with the controller 34 provided in the form of an electrical circuit board. The controller 34 includes a hand-held remote 108 which may be remotely located from the housing 30 of the delivery unit 14. An automated timing unit 110 is in operable communication with the controller 34 and is adapted to allow preprogramming of the controller 34, such that the dispersion apparatus 10 may be set to automatically run through specified timed cycles at predetermined time intervals, thereby eliminating the necessity of constant manual operation of the dispersion apparatus 10. The air compressor 32 of the instant example may further be replaced by a compressor providing a relatively high pressurized air output, thereby allowing a single compressor to be utilized with a plurality of nozzle assemblies 22 remotely located from one another.

In operation, the controller 34 operates to provide an electrical input to the air compressor 32 that in turn provides pressurized air via supply line 36 to the nozzle assembly 22. The pressurized air as provided by the compressor 32 is received into the space 76 of the nozzle assembly 22, thereby forcing air over the discharge aperture 90 of each nozzle 26, thereby creating a vacuum in the area surrounding each nozzle 26 as caused by a venturi-type effect. The angled slots 86 within the head portion 82 of each nozzle 26 causes a cyclonic action, thereby assisting in a more effective atomizing process. The vacuum draws the liquid bird repellant 20 upwardly through the filter members 96 and supply lines 28 to each associated nozzle 26. As the liquid bird repellant 20 exits the discharge aperture 90 of each nozzle 26, the liquid bird repellant 20 is atomized resulting in the atomized bird repellant 38. The particle size of the atomized bird repellant is preferably ≦about 20 μm, more preferably is ≦about 10 μm, and most preferably is ≦about 10 μm for at least 50% of the atomized bird repellant. It has been determined that sufficient small particles of the bird repellant are required to optimize the effects of the repellant on the inhaling birds. The continuous supply of air from the air compressor 32 to the nozzle housing 24 forces the atomized bird repellant 38 through the apertures 70 of the cover member 58 and into the interior space 18 of the tank 16. Preferably, the nozzle assembly 22 (FIG. 6) is positioned within the interior space 18 of the tank 16 such that particles of significant size impact a sidewall 40 of the tank 16, where the larger particles collect and eventually return to the liquid bird repellant 20 to be supplied to the nozzle assembly 22. Sufficiently atomized bird repellant 38 exits the tank 16 via the exhaust port 52 where the atomized bird repellent 38 is filtered through the filter member 106. Preferably, the filter member 106 is constructed such that particles larger than about 20 μm are trapped within the filter member, thereby preventing their escape from within the tank 16, thereby optimizing the effect on the birds.

A gauge member 112 is provided in operable communication with the interior space 18 of the tank 16 so as to provide a visual indication of the level of the liquid bird repellant 20 within the tank 16. In the illustrated example, the gauge member 112 includes a pair of fittings and a transparent tube 116. In operation, fluid enters at least one of the fittings 114 through apertures 118 extending through a sidewall 40 of the tank 16. The liquid bird repellant 20 then enters the tube 116 where it can be visually inspected.

The present inventive method and related apparatus provide a low cost and economical solution to dispersing birds from both interior spaces and exterior areas. The methods and related apparatus also provides a low-noise, less obstructive, and less intrusive solution to bird dispersion. Specifically, the methods and apparatus are highly effective at dispersing birds, while reducing the amount of bird repellant required to be effective and simultaneously increasing the relative effectiveness of the repellant, safe to use around consumable products, and safe to use around safety-critical areas, such as airports.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A method for dispersing a bird repellant, comprising:
providing a tank defining an interior space;
placing a quantity of bird repellant in liquid form within the interior space of the tank;
providing a nozzle assembly including at least one nozzle in fluid communication with the interior space of the tank, the at least one nozzle including a discharge aperture;
providing an air pressurizing source; and
atomizing a portion of the bird repellant by moving air over the discharge aperture of the at least one nozzle via the air pressurizing source, thereby providing an atomized bird repellant.

2. The method of claim 1, wherein the atomizing step results in the atomized bird repellant having a particle size of less than or equal to about 20 μm.

3. The method of claim 2, wherein the atomizing step results in the atomized bird repellant having a particle size of less than or equal to about 10 μm.

4. The method of claim 3, wherein the atomizing step results in the atomized bird repellant having a particle size of less than or equal to about 10 μm for at least 50% of the atomized bird repellant.

5. The method of claim 4, wherein the liquid bird repellant is maintained at substantially an ambient temperature prior to the atomizing step.

6. The method of claim 5, further including:
filtering the atomized bird repellant through a first filter member.

7. The method of claim 6, wherein the filtering step filters particles from the atomized bird repellant of greater than about 20 μm in size.

8. The method of claim 6, further including:
filtering the liquid bird repellant through a second filter member prior to the step of atomizing a portion of the liquid bird repellant.

9. The method of claim 6, wherein the step of providing the nozzle assembly includes locating the nozzle assembly within the interior of the tank; and further including:
positioning the nozzle assembly within the interior space of the tank such that at least a portion of the atomized bird repellant collides with an interior surface of the tank and remains within the interior space of the tank.

10. The method of claim 1, further including:
providing a controller that operably controls the air pressurizing source.

11. The method of claim 10, wherein the step of providing the controller includes providing a timing mechanism that automatically controls the air pressurizing source to operate at preprogrammed time intervals.

12. The method of claim 1, wherein the liquid bird repellant is maintained at substantially an ambient temperature prior to the atomizing step.

13. The method of claim 1, further including:
filtering the atomized bird repellant through a filter member.

14. The method of claim 13, wherein the filtering step filters particles from the atomized bird repellant of greater than about 20 μm in size.

15. The method of claim 1, further including:
filtering the liquid bird repellant prior to the step of atomizing a portion of the liquid bird repellant.

16. The method of claim 1, wherein the step of providing the nozzle assembly includes locating the nozzle assembly within the interior of the tank; and further including:
positioning the nozzle assembly within the interior space of the tank such that at least a portion of the atomized bird repellant collides with an interior surface of the tank and remains within interior space of the tank.

17. A method for dispersing a bird repellent utilizing a hazing apparatus that includes a tank having an interior space adapted to receive a liquid within at least a portion thereof, a nozzle assembly located within the interior space of the tank and having a nozzle housing and at least one nozzle located within the nozzle housing, each nozzle having a discharge aperture, a supply line providing fluid communication between the portion of the interior space of the tank containing the liquid and the at least one nozzle, a first filter member located so as to filter the fluid prior to the fluid entering the at least one nozzle, a compressor in fluid communication with the nozzle housing and adapted to provide an air flow through the nozzle housing, a controller in operable communication with the compressor, and a second filter member located so as to filter an atomized fluid exiting the nozzle assembly, the method comprising:
placing a quantity of bird repellant in liquid form within the interior space of the tank; and
atomizing a portion of the liquid bird repellant by forcing air over the discharge aperture of the at least one nozzle via the compressor, thereby providing an atomized bird repellant.

18. The method of claim 17, wherein the atomizing step results in the atomized bird repellant having a particle size of less than or equal to about 20 μm.

19. The method of claim 18, wherein the atomizing step results in the atomized bird repellant having a particle size of less than or equal to about 10 μm.

20. The method of claim 19, wherein the atomizing step results in the atomized bird repellant having a particle size of less than or equal to about 10 μm for at least 50% of the atomized bird repellant.

21. The method of claim 20, wherein the liquid bird repellant is maintained at substantially an ambient temperature prior to the atomizing step.

22. The method of claim 21, further including:
controlling the compressor via the controller to operate at preprogrammed time intervals.

23. The method of claim 22, further including:
filtering the atomized bird repellant through a second filter member, wherein the second filter filters particles that are greater than about 20 μm in size.

24. The method of claim 23, further including:
positioning the nozzle assembly within the interior space of the tank such that at least a portion of the atomized bird repellant collides with an interior surface of the housing and remains within the interior space of the tank.

25. The method of claim 17, wherein the liquid bird repellant is maintained at substantially an ambient temperature prior to the atomizing step.

26. The method of claim 17, further including:
controlling the compressor via the controller to operate at preprogrammed time intervals.

27. The method of claim 17, further including:
filtering the atomized bird repellant through a second filter member, wherein the second filter filters particles that are greater than about 20 μm in size.

28. The method of claim 17, further including:
positioning the nozzle assembly within the interior space of the tank such that at least a portion of the atomized bird repellant collides with an interior surface of the housing and remains within the interior space of the tank.

29. An apparatus for dispersing a bird repellant, comprising
a tank having an interior space adapted to receive a liquid bird repellent within at least a portion thereof;
a nozzle assembly located within the interior space of the tank and having a nozzle housing and at least one nozzle located within the nozzle housing, the nozzle housing including a first portion, a second portion and an O-ring providing a fluid-tight seal between the first portion and the second portion, wherein the O-ring is constructed of a material that is substantially non-reactive with a bird repellant, the at least one nozzle being in fluid communication with the portion of the interior space of the housing adapted to received the liquid bird repellant and including a discharge aperture; and
a compressor in fluid communication with the nozzle tank and adapted to provide an air flow through the nozzle tank and over the discharge aperture of the at least one nozzle which draws the liquid bird repellent from the at least one nozzle and atomizes the liquid bird repellent.

30. The apparatus of claim 29, wherein the bird repellant comprises methyl anthranilate.

31. The apparatus of claim 30, wherein the O-ring is constructed of VITON®.

32. The apparatus of claim 29, wherein at least the portion of the tank adapted to receive the liquid bird repellent is constructed of a material that is substantially non reactive with a bird repellent.

33. The apparatus of claim 32, wherein at least the portion of the housing adapted to receive the liquid bird repellent is constructed of a material that is substantially non-reactive with methyl anthranilate.

34. The apparatus of claim 33, wherein at least the portion of the housing adapted to receive the liquid bird repellent therein is constructed of stainless steel.

35. The apparatus of claim 32, wherein the nozzle assembly is configured to provide atomized bird repellent in particles of less than or equal to about 20 μm.

36. The apparatus of claim 35, wherein the nozzle assembly is configured to provide atomized bird repellent in particles of less than or equal to about 10 μm.

37. The apparatus of claim 36, wherein the nozzle assembly is configured to provide atomized bird repellent in particles of less than or equal to about 10 μm for at least 50% of the atomized bird repellant.

38. The apparatus of claim 37, further including:
a first filter member located so as to filter the atomized bird repellant subsequent to atomization.

39. The apparatus of claim 38, further including:
a second filter member located so as to filter the fluid bird repellant prior to the fluid bird repellant entering the at least one nozzle.

40. The apparatus of claim 39, further including:
a controller in operable communication with the compressor for operably controlling the compressor.

41. The apparatus of claim 40, wherein the controller further includes a timing mechanism adapted to automatically control the compressor to operate at preprogrammed time intervals.

42. The apparatus of claim 29, wherein at least the portion of the tank adapted to receive the liquid bird repellent is constructed of stainless steel.

43. The apparatus of claim 29, further including:
a filter member located so as to filter the atomized bird repellant subsequent to atomization.

44. The apparatus of claim 29, further including:
a filter member located so as to filter the fluid bird repellant prior to the fluid bird repellant entering the at least one nozzle.

45. The apparatus of claim 29, further including:
a controller in operable communication with the compressor for operably controlling the compressor.

46. The apparatus of claim 45, wherein the controller further includes a timing mechanism adapted to automatically control the compressor to operate at preprogrammed time intervals.

47. The apparatus of claim 29 further including:
a gauge member in operable communication with the interior space of the housing and adapted to provide a visual indication of a level of the liquid bird repellent within the interior space of the housing.

48. The apparatus of claim 47, wherein the gauge member includes a transparent tube in fluid communication with the interior space of the housing.
